(19) United States
(12) Patent Application Publication
(10) Pub. No.: US 2025/0029106 A1
(43) Pub. Date: Jan. 23, 2025

(54) AUTOMATED RULE CREATION FOR FRAUD DETECTION USING A MACHINE LEARNING-DRIVEN COMPUTING FRAMEWORK

(71) Applicant: Actimize LTD., Ra'anana (IL)

(72) Inventors: Danny BUTVINIK, Haifa (IL); Akshay ARORA, Pune, Maharashtra (IN); Aditya JOHAR, Pune (IN); Nikhil Khemrao KOSARE, Pune (IN)

(21) Appl. No.: 18/356,346

(22) Filed: Jul. 21, 2023

(51) Int. Cl. G06Q 20/40

(52) U.S. Cl. CPC G06Q 20/4016

(57) ABSTRACT

A rule training system and methods are provided that are configured to generate machine learning rules for fraud detection based on an automated feature selection by a rule creation system. The system includes a processor and a computer readable medium operably coupled thereto, the computer readable medium comprising a plurality of instructions stored in association therewith that are accessible to, and executable by, the processor, to perform rule creation operations which include accessing a training dataset, performing a data preprocessing and a data sampling on the training dataset, obtaining a plurality of features from the processed and sampled dataset using a feature engineering operation, selecting a subset of features from the plurality of features using simulated annealing operations, generating the plurality of detection rules using the subset of features, iteratively selecting from the plurality of detection rules, and evaluating a rule performance of each rule in those selected.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to artificial intelligence (AI) and machine learning (ML) systems and models, such as those that may be used for fraud detection with financial institutions, and more specifically to a system and method for programmatically automating rule creation through automated feature selection and rule performance analysis.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized (or be conventional or well-known) in the prior art. The subject matter in the background section merely represents different approaches, which in and of themselves may also be inventions.

AI and ML are beginning to rapidly impact all facets of contemporary life, providing cutting-edge solutions for various industries. One area where the application of AI and ML has gained considerable traction is in the domain of financial crime, where ML solutions are being increasingly adopted to counter fraudulent activities. For example, ML algorithms have been used for fraud detection, which has emerged as a frequent and beneficial use of ML models and systems for investigating and preventing fraud in financial systems. In comparison to a traditional fraud detection approach based on rules, ML-based approaches are a much more powerful and accurate method that can effectively address the scope and scale of modern production requirements. Nonetheless, rule-based approaches remain relevant and continue to play a role in end-to-end solutions. Once an ML model provides a predictive score for a specific transaction, the transaction then undergoes a verification and validation stage using rule-based engines. During this stage, decisions are made regarding the future state of the transaction based on strategies and policies that determine the actionable items concerning the transaction. These policies rely on rules acquired over time, which may be created based on business rules, past use cases, and common knowledge by subject matter experts.

However, maintaining, updating, acquiring, and executing rules is not trivial and suffers from inaccuracies, imprecisions, and the inability to adapt to a changing environment. Rules become outdated and generation of new rules is inefficient in terms of both time and cost. Further, rules generated by users require subject matter expertise and knowledge of the field, financial institution, customer, and the like. This creates a system that is inefficient to establish, update, and maintain. When rules become out of date, those rules may be inaccurate and/or require additional resources to store and process, making rule-based systems inefficient and wasteful to valuable computing resources. Thus, it is desirable to address these challenges with rule-based engines and therefore there is a need to develop a system for programmatically automating rule creation for computing systems, models, and engines to maintain updated, efficient, and accurate fraud detection systems.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. In the figures, elements having the same designations have the same or similar functions.

FIG. 1 is a simplified block diagram of a networked environment suitable for implementing the processes described herein according to an embodiment.

FIG. 2 is a simplified diagram of a computing architecture to programmatically automate feature selection and detection rule creation using an ML framework implementing a simulated annealing process according to some embodiments.

FIG. 3 is a simplified diagram of detection rules that are automatically created using an ML framework implementing a simulated annealing process according to some embodiments.

FIG. 4 is a simplified diagram of ML operations used for automatic feature selection and rule creation using a simulated annealing process according to some embodiments.

FIG. 5 is a simplified diagram of an exemplary flowchart for programmatically automating rule creation for detection rules using a machine-learning driven computing framework according to some embodiments.

FIG. 6 is a simplified diagram of a computing device according to some embodiments.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

In order to programmatically create detection rules from automatically selected features, a rule creation ML system and/or model(s) may utilize a set of training data to create and recommend rules. ML models may be built on different tenants of a fraud detection and/or ML model training system, such as different financial institutions, using historical or past activities, transactions, and/or other model training data. The ML operations and system may utilize the rule training data to select features and create detection rules in an automatic, data-driven manner, thus allowing the ML system to generate rules with more accurate fraud strategies. The ML system for decision rule generation may further reduce the dependency on a human factor for rule generation, thereby reducing manual errors related to rule simulation, rule coding, or rule deployment. This allows service provider systems to offload complicated and lengthy data analysis tasks required during rule testing, deployment, and lifecycle monitoring, which increases computational efficiency in generating, maintaining, and updating such ML models and rules.

A service provider may provide a computing framework for automatic generation of rules using an ML approach that facilitates the development of detection rules for fraudulent transactions and/or other ML tasks. The framework may streamline ML-based solutions for fraud detection by reducing the need for maintaining, storing, calculating, adapting, and updating complex and time-consuming rules in the final stages of fraud detection. By automating these tasks, ML-based rules can accelerate time-to-value and time-to-insight for customers, decrease expensive processes associated with fraud investigations, better align with scalable production, and facilitate the rapid deployment of models in production environments. This approach improves computer automated fraud detection by leveraging ML models and capabilities to improve the accuracy, efficiency, and effectiveness of the rules in rule policy manager systems while minimizing costs and resource requirements on the client side.

Fraud detection is a process that detects and prevents fraudsters from obtaining money or property through fraud. It is a set of activities undertaken to detect, inhibit, and preferably block the attempt of fraudsters to obtain money or property fraudulently. Fraud detection is prevalent across banking, insurance, medical, government, and public sectors, as well as law enforcement agencies. Fraudulent activities include money laundering, cyberattacks, fraudulent banking claims, forged bank checks, identity theft, and other illegal and/or malicious practices and conduct. As a result, organizations implement modern fraud detection and prevention technologies with risk management strategies to combat growing fraudulent transactions across diverse platforms.

Deploying AI for fraud prevention has helped companies enhance their internal security and streamline business processes. However, operationalization of AI in real systems and real-time fraud detection to implement and use ML models in financial fraud detection systems remains difficult, time consuming, and resource intensive. A strategy (referred to herein as a “detection rule,” “decision rule,” or simply “rule”) may be established to determine a set of conditions to be met (in conjunction with the model risk score or other classification, prediction, or output) for an alert to be generated, a payment to be blocked or delayed, or a step-up to be issued to the user/customer, or the like. Many financial institutions and/or customers of service providers (e.g., providers of fraud detection and/or prevention systems) may primarily rely on the experience and intelligence of their fraud strategy team in generating and configuring these rules, as well as identifying the best combination of conditions that maximizes fraud detection and minimizes false positives, thus reducing customer friction. This challenging task would typically require a significant amount of data to research. Since most financial institutions have no solid “housekeeping” practices, the rules created as part of business-as-usual tend to pile up and age, becoming outdated as business practices and fraudsters change over time, thereby creating more “noise” than value.

Thus, the framework discussed herein provided by a fraud detection system or other service provider may assist fraud strategists with creating and identifying (and updating and/or replacing) these rules and rules combinations in an automated, data-driven manner, thus allowing them to develop more accurate fraud detection and prevention strategies, reduce the dependency on the human factor, and reduce manual errors related to rules simulation, rule coding, or rule deployment. The framework may include a computing system having a fraud hub including data management, analytics engines, and strategy and investigation management. This may be used detect fraudulent activities on an account and alert and investigate, which may begin with autonomous fraud management. A policy manager may provide tools that allow users and systems to create, manage, store, alter and execute single or multiple policies, which are different sets of applications configured differently for different use cases. The policy manager can simplify configuration by allowing for multiple sets of fraud investigations to be configured differently. The policy manager allows creation of new policies beyond a default policy and may expedite the final processing of a transaction, such as by routing a suspicious transaction, deciding on opening suspicious activity report (SAR), facilitating investigation processes, and/or regulating a further status of a transaction.

SARs may be documents that financial institutions, and those associated with their business, file with the Financial Crimes Enforcement Network (FinCEN) whenever there is a suspected case of money laundering or fraud. These reports are tools to help monitor activity within finance-related industries that is deemed out of the ordinary, a precursor of illegal activity, or might threaten public safety. SARs are a tool provided by the Bank Secrecy Act (BSA) and mainly used to help financial institutions detect and report known or suspected violations. SARs enable law enforcement agencies to uncover and prosecute significant money laundering, criminal financial schemes, and other illegal endeavors. SARs give governments an opportunity to spot and analyze emerging trends and patterns across a broad spectrum of personal and organized crimes. With this knowledge, institutions and governments can anticipate and counteract fraudulent and criminal behavior before it gains a foothold.

The embodiments described herein provide methods, computer program products, and computer database systems for an ML system for determining and programmatically selecting ML features, which may then be used for creating decision or detection rules for ML systems. A financial institution or other service provider system may therefore include a fraud detection system that may access different transaction datasets and detect fraud using programmatically generated detection rules. The system may generate, select, and/or evaluate features using a simulated annealing operation, and thereafter apply those features when programmatically creating detection rules in an automated and programmatic manner without manual efforts and user intervention, which may be done using ML algorithms, models, and systems. The system may then create and transmit alerts for fraud detection or other ML task using such detection rules in intelligent fraud detection or other predictive analytic systems.

According to some embodiments, in an ML system accessible by a plurality of separate and distinct organizations, ML algorithms, features, and models are provided for identifying, generating, and providing detection rules in a programmatic manner through automated feature selection and simulated annealing, thereby providing faster, more efficient, and more precise detection rules creation that may be implemented in AI systems.

### Example Environment

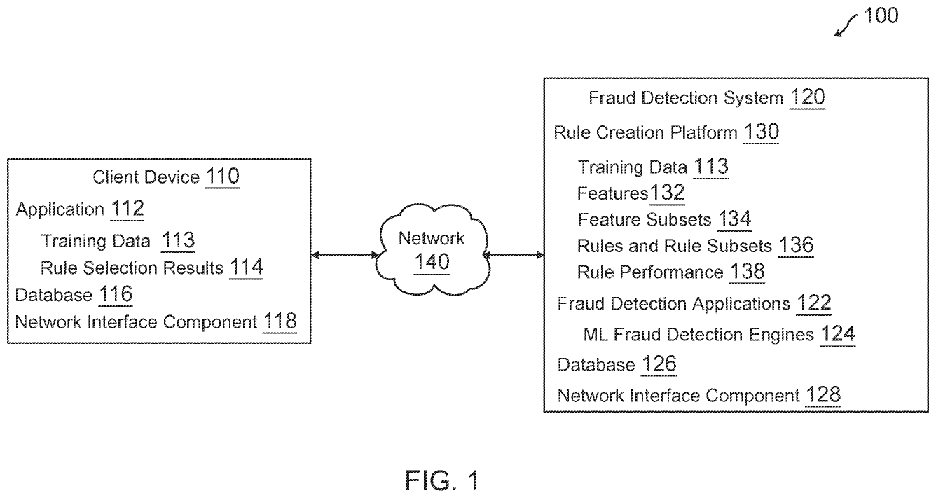

The system and methods of the present disclosure can include, incorporate, or operate in conjunction with, or in the environment of, an ML engine, model, and intelligent system, which may include an ML or other AI computing architecture that provides an automated and programmatic decision rule generation system. FIG. 1 is a block diagram of a networked environment 100 suitable for implementing the processes described herein according to an embodiment. As shown, environment 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided, by such devices and/or servers may be combined or separated for a given embodiment and may be performed by a greater number or fewer number of devices and/or servers. For example, ML models, NNs, and other AI architectures have been developed to improve predictive analysis and classifications by systems in a manner similar to human decision-making, which increases efficiency and speed in performing predictive analysis of transaction datasets and/or other data requiring machine predictions, classifications, and/or analysis. One or more devices and/or servers may be operated and/or maintained by the same or different entities.

FIG. 1 illustrates a block diagram of an example environment 100 according to some embodiments. Environment 100 may include a client device 110 and a fraud detection system 120 that interact over a network 140 to provide intelligent detection and/or prevention of fraud, as well as other predictive classifications, through one or more ML models that utilize detection rules that are created programmatically using ML operations discussed herein. In other embodiments, environment 100 may not have all of the components listed and/or may have other elements instead of, or in addition to, those listed above. In some embodiments, environment 100 is an environment in which programmatic rule generation may be performed through an ML or other AI system. As illustrated in FIG. 1, fraud detection system 120 might interact via a network 140 with client device 110, which generates, provides, and outputs detection rules for use with ML models and engines during fraud detection or other intelligent classifications, outputs, scoring, decision-making, and/or predictions.

For example, in fraud detection system 120, fraud detection applications 122 may process transaction data and return a predictive score from an ML model, such as one utilized by ML fraud detection engines 124 to intelligently detect fraud using models and detection rules for model outputs. ML fraud detection engines 124 may use a policy manager, where conventionally the policy manager unit may decide how to process or act on different transactions based on the rules created manually, based on business use cases, and/or from best practices. However, creating and tuning rules, while critical, is manual, time-consuming, and requires a high degree of subject matter expertise. As such, rule creation platform 130 may be implemented to automate rule creation through intelligent feature selection and simulated annealing during rule creation, which offers significant advantages, including the reduction of time-to-value and time-to-insight for customers, cost savings in fraud investigations, improved accuracy, precision, and relevance of generated rule-based data-driven approaches, and the like. These improvements may be realized through ML-based systems of rule creation platform 130, which provide enhanced decision-making capabilities by the policy manger, creation of highly optimized rules and coverage, and/or reduced redundancy in rule logic.

Fraud detection system 120 may be utilized to determine detection rules for use with ML models that implement, provide alert and/or notifications for, and/or execute ML tasks in response to particular input data. Client device 110 may include an application 112 that provides training data 113 for rule training and receives rule selection results 114 for detection rules generated from training data 113. Fraud detection system 120 includes a rule creation platform 130 for programmatic rule generation using ML operations. Fraud detection system 120 further includes fraud detection applications 122 to provide fraud detection services, which may include and/or be utilized in conjunction with computing services provided to customers, tenants, and other users or entities accessing and utilizing fraud detection system 120. In this regard, fraud detection applications 122 may include ML fraud detection engines 124 that implement detection rules provided to client device 110 with rule selection results 114 that are reviewed for selection and/or implementation of detection rules with ML fraud detection engines 124. However, in other embodiments, such selected rules from rule selection results 114 may be utilized with other ML systems and models, such as those managed by separate computing systems, servers, and/or devices (e.g., tenant-specific or controlled servers and/or server systems that may be separate from the programmatic rule generation discussed herein).

As such, fraud detection applications 122 may include ML fraud detection engines 124 utilizing ML models that generate alerts using and/or execute an automated computing task, action, or operation based on detection rules generated using training data 113 by rule creation platform 130. ML fraud detection engines 124 may implement detection rules from ML models (e.g., decision trees and corresponding branches) trained from training data 113, which may correspond to historical data used to provide a basis or background to each corresponding ML model. This may include performing feature engineering and/or selection of features associated with features or variables used by ML models, identifying data for features or variables in training data 113, and using one or more ML algorithms, operations, or the like for rule creation (e.g., including configuring decision trees or neural networks, weights, activation functions, input/hidden/output layers, and the like). After initial training of ML models using supervised or unsupervised ML algorithms (or combinations thereof), ML models may determine detection rules usable in a production computing environment to predict alerts, execute actions, classify data, or otherwise provide fraud detection for instances and/or occurrences of particular data (e.g., input transaction data indicating fraud or not).

Thus, the components in environment 100 may be implemented for ML systems that programmatically generate detection and decision rules for rule-based engines used during fraud detection. In this regard, when determining an effectiveness of policy manager detection rules, two major parameters may be utilized, detection rate (DR, e.g., the number of frauds that rule is able to identify as risky from the total population of frauds) and false positive ratio (FPR, e.g., the number of false positives generated by the rule against each fraud it is able to determine), which may be evaluated for creation and/or implementation of detection rules. As such, rule writers and/or administrators managing the policy manager may determine that the rule may be useful only when it has a high DR and a low FPR, which requires optimization for both parameters.

When generating rules, a feature selection algorithm of simulated annealing may be used by rule creation platform 130 using training data 113. Initially, the process may include feature selection where rule creation platform 130 may select a subset of “X” available features. X features may be any number less than the total number of features available for the transactions from training data 113 and/or a fraud management system, such as fraud detection applications 122. Thereafter, the operations for simulated annealing may be performed, which may first include encoding a solution having the combination of features 132 in feature subsets 134 encoded in a solution vector. Each element in the vector may represent a specific aspect of a corresponding detection rule for creation. For example, features 132 for feature subsets 134 may be represented as indices or binary values when encoded. The system may generate a random initial solution by selecting a random combination of features 132, thresholds, rule conditions, and operands. The system may further evaluate the initial solution using the labeled dataset from training data 113 and corresponding F1 score (e.g., a harmonic means of precision and recall, which may correspond to an ML metric for classification models). F1 scores may be calculated using the precision, such as the ratio of true positives to all positives (e.g., true and false positives), and recall, such as the ratio of true positives to all true positives and false negatives.

Thereafter, neighbor generation may be performed where the system may define a neighborhood function to generate a new solution by modifying the current solution. This may be performed by changing one or more elements of the solution vector, such as by adding/removing a feature from feature subsets 134 used for encoding the solution, altering a threshold value, switching a rule condition, or changing an operand. Rule creation platform 130 may define an objective function that calculates the F1 score of the decision tree classifier for a solution to reflect the quality of the solution. Rule creation platform 130 may define an initial temperature and a cooling schedule for the annealing process. The temperature controls the probability of accepting worse solutions, which may be used for escaping local optima. The cooling schedule gradually decreases the temperature, making the algorithm more selective over time. During an iterative process, rule creation platform 130 may perform the following steps until a stopping criterion is met (e.g., a maximum number of iterations or a predefined temperature threshold). The iterative process may include generating a neighboring solution from the current solution using the neighborhood function, evaluating the neighboring solution using the labeled dataset and calculating the neighboring solution's F1 score, calculating the objective function for the neighboring solution, and computing the difference in objective function values between the neighboring and current solutions. If the neighboring solution is better (e.g., a higher objective function value), the neighboring solution may be selected as a new current solution. However, if the neighboring solution is worse, the neighboring solution may be accepted with a probability dependent on a difference in the objective function values and the current temperature. Thereafter, the temperature may be updated according to the cooling schedule.

Rule creation platform 130 may utilize these operations to generate and/or obtain the final solution vector at the end of the iterative process, which represents the optimized combination of features that maximizes harmonic mean of precision and recall (F1 score) for training data 113. Thus, the system may use ML algorithms for simulated annealing and other ML operations to generate feature subsets 134 that may be used when creating rules and rule subsets 136 used for detecting fraudulent transactions. The system for automated rule generation using ML-driven models and outputs may create rules and rule subsets 136 having high DRs and low FPRs based on features selected using simulated annealing.

Once feature subsets 134 have been determined, rules and rule subsets 136 may be created using features extracted from the best solution vector output by the simulated annealing process. A decision tree classifier may be fit with selected features from feature subsets 134 and training data 113 may be used for training. A classifier object may be hyper tuned using set hyperparameters, and rules that are generated using training data 113 with feature subsets 134 may be evaluated through rule performance 138. Rule performance 138 may include measuring a total number of transactions falling into the rule, calculated FPR, calculating DR, discarding the rule if FPR is greater than 100 (or another threshold, such as a percentage of transactions), and/or discarding the rule if DR is less than 5% (or another threshold). For all selected rules, if the total measured detections of frauds in training data 113 is less than 50% (or another threshold), another iteration classifying the data may follow. Otherwise, rules and rule subsets 136 created using feature subsets 134 may be provided to fraud detection applications 122 for use with ML fraud detection engines 124.

Thus, the service provider's automated rule generation system may execute a probabilistic optimization algorithm using the annealing process for selection of “indicative” features. These indicative features may then be used to generate rules from a decision tree classifier. The algorithm explores the solution space by iteratively generating and evaluating neighboring solutions. The algorithm accepts better solutions with a higher probability and allows occasional acceptance of worse solutions to escape local optima. Rules and rule subsets 136 with rule performance 138 thereafter provide recommendations including outputs for analysis and optimization, such as rule selection results 114 provided to application 112 on client device 110. This allows selection and configuration of programmatically generated detection rules with ML engines.

One or more client devices and/or servers (e.g., client device 110 using application 112) may execute a web-based client that accesses a web-based application for fraud detection system 120, or may utilize a rich client, such as a dedicated resident application, to access fraud detection system 120, which may be provided by fraud detection applications 122 to such client devices and/or servers. Client device 110 and/or other devices or servers may utilize one or more application programming interfaces (APIs) to access and interface with fraud detection applications 122 and/or ML fraud detection engines 124 of fraud detection system 120 in order to schedule, review, and execute ML modeling and decision rule generation using the operations discussed herein. Interfacing with fraud detection system 120 may be provided through an application for fraud detection applications 122 and/or ML fraud detection engines 124 and may be based on data stored by database 126, fraud detection system 120, client device 110, and/or database 116. Client device 110 and/or other devices and servers on network 140 might communicate with fraud detection system 120 using TCP/IP and, at a higher network level, use other common Internet protocols to communicate, such as hypertext transfer protocol (HTTP or HTTPS for secure versions of HTTP), file transfer protocol (FTP), wireless application protocol (WAP), etc. Communication between client device 110 and fraud detection system 120 may occur over network 140 using a network interface component 118 of client device 110 and a network interface component 238 of fraud detection system 120. In an example where HTTP/HTTPS is used, client device 110 might include an HTTP/HTTPS client for application 112, commonly referred to as a “browser.” for sending and receiving HTTP/HTTPS messages to and from an HTTP/HTTPS server, such as fraud detection system 120 via the network interface component.

Similarly, fraud detection system 120 may host an online platform accessible over network 140 that communicates information to and receives information from client device 110. Such an HTTP/HTTPS server might be implemented as the sole network interface between client device 110 and fraud detection system 120, but other techniques might be used as well or instead. In some implementations, the interface between client device 110 and fraud detection system 120 includes load sharing functionality. As discussed above, embodiments are suitable for use with the Internet, which refers to a specific global internet of networks. However, it should be understood that other networks can be used instead of or in addition to the Internet, such as an intranet, an extranet, a virtual private network (VPN), a non-TCP/IP based network, any LAN or WAN, or the like.

Client device 110 and other components in environment 100 may utilize network 140 to communicate with fraud detection system 120 and/or other devices and servers, and vice versa, which is any network or combination of networks of devices that communicate with one another. For example, network 140 can be any one or any combination of a local area network (LAN), wide area network (WAN), telephone network, wireless network, point-to-point network, star network, token ring network, hub network, or other appropriate configuration. As the most common type of computer network in current use is a transfer control protocol and Internet protocol (TCP/IP) network, such as the global inter network of networks often referred to as the Internet. However, it should be understood that the networks that the present embodiments might use are not so limited, although TCP/IP is a frequently implemented protocol. Further, one or more of client device 110 and/or fraud detection system 120 may be included by the same system, server, and/or device and therefore communicate directly or over an internal network.

According to one embodiment, fraud detection system 120 is configured to provide webpages, forms, applications, data, and media content to one or more client devices and/or to receive data from client device 110 and/or other devices, servers, and online resources. In some embodiments, fraud detection system 120 may be provided or implemented in a cloud environment, which may be accessible through one or more APIs with or without a correspond graphical user interface (GUI) output. Fraud detection system 120 further provides security mechanisms to keep data secure. Additionally, the term “server” is meant to include a computer system, including processing hardware and process space(s), and an associated storage system and database application (e.g., object-oriented data base management system (OODBMS) or relational database management system (RDBMS)). It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

In some embodiments, client device 110, shown in FIG. 1, executes processing logic with processing components to provide data used for ML fraud detection engines 124 of fraud detection system 120 during use of fraud detection applications 122, as well as rule generation using rule creation platform 130. In some embodiments, this may include providing training data 113 based on datasets to be processed for decision rule generation, such as transaction data for ML fraud detection using ML engines and detection rules for actionable tasks. In one embodiment, client device 110 includes application servers configured to implement and execute software applications as well as provide related data, code, forms, webpages, platform components or restrictions, and other information associated with datasets for detection rules and ML models, and to store to, and retrieve from, a database system related data, objects, and web page content associated with detection rules and ML models. For example, fraud detection system 120 may implement various functions of processing logic and processing components, and the processing space for executing system processes, such as running applications for decision rule generation and/or ML modeling. Client device 110 and fraud detection system 120 may be accessible over network 140. Thus, fraud detection system 120 may send and receive data to client device 110 via network interface component 128. Client device 110 may be provided by or through one or more cloud processing platforms, such as Amazon Web Services® (AWS) Cloud Computing Services, Google Cloud Platform®, Microsoft Azure® Cloud Platform, and the like, or may correspond to computing infrastructure of an entity, such as a financial institution.

Several elements in the system shown and described in FIG. 1 include elements that are explained briefly here. For example, client device 110 could include a desktop personal computer, workstation, laptop, notepad computer, PDA, cell phone, or any wireless access protocol (WAP) enabled device or any other computing device capable of interfacing directly or indirectly to the Internet or other network connection. Client device 110 may also be a server or other online processing entity that provides functionalities and processing to other client devices or programs, such as online processing entities that provide services to a plurality of disparate clients.

Client device 110 may run an HTTP/HTTPS client, e.g., a browsing program, such as Microsoft's Internet Explorer or Edge browser, Mozilla's Firefox browser, Opera's browser, or a WAP-enabled browser in the case of a cell phone, tablet, notepad computer, PDA or other wireless device, or the like. According to one embodiment, client device 110 and all of its components are configurable using applications, such as a browser, including computer code run using a central processing unit such as an Intel Pentium® processor or the like. However, client device 110 may instead correspond to a server configured to communicate with one or more client programs or devices, similar to a server corresponding to fraud detection system 120 that provides one or more APIs for interaction with client device 110 in order to submit datasets, select datasets, and perform rule modeling operations for an ML system configured for fraud detection.

Thus, client device 110 and/or fraud detection system 120 and all of their components might be operator configurable using application(s) including computer code to run using a central processing unit, which may include an Intel Pentium® processor or the like, and/or multiple processor units. A server for client device 110 and/or fraud detection system 120 may correspond to Window®, Linux®, and the like operating system server that provides resources accessible from the server and may communicate with one or more separate user or client devices over a network. Exemplary types of servers may provide resources and handling for business applications and the like. In some embodiments, the server may also correspond to a cloud computing architecture where resources are spread over a large group of real and/or virtual systems. A computer program product embodiment includes a machine-readable storage medium (media) having instructions stored thereon/in which can be used to program a computer to perform any of the processes of the embodiments described herein utilizing one or more computing devices or servers.

Computer code for operating and configuring client device 110 and fraud detection system 120 to intercommunicate and to process webpages, applications and other data and media content as described herein are preferably downloaded and stored on a hard disk, but the entire program code, or portions thereof, may also be stored in any other volatile or non-volatile memory medium or device, such as a read only memory (ROM) or random-access memory (RAM), or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory integrated circuits (ICs)), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, virtual private network (VPN), LAN, etc.) using any communication medium and protocols (e.g., TCP/IP, HTTP, HTTPS, Ethernet, etc.) as are well known. It will also be appreciated that computer code for implementing embodiments of the present disclosure can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun MicroSystems, Inc.).

### Simulated Annealing and Decision Rule Generation

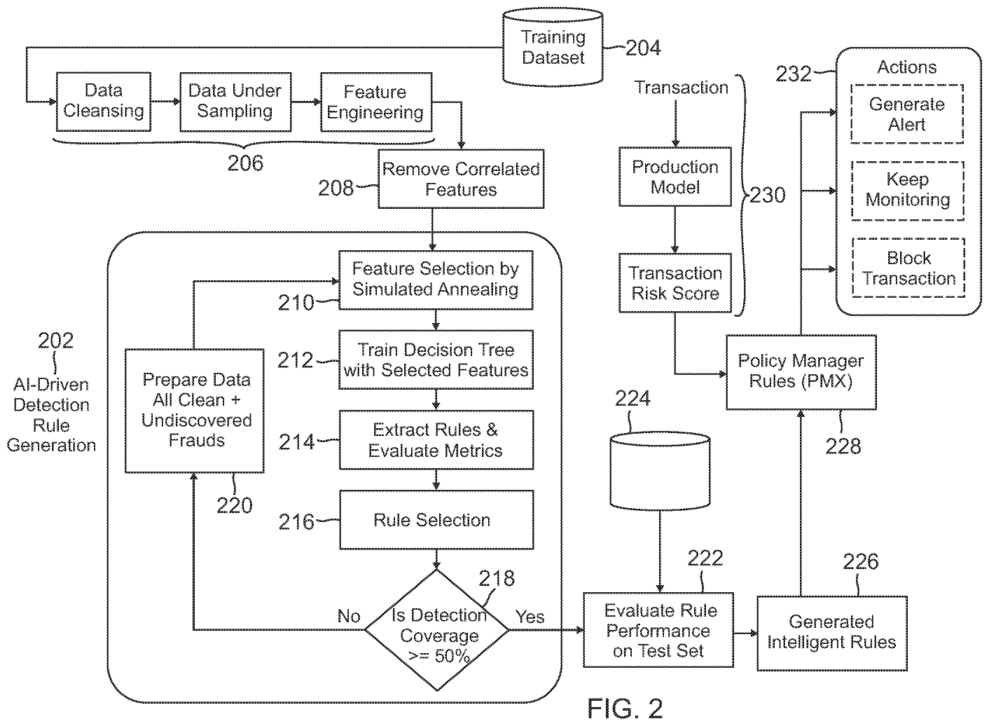

FIG. 2 is a simplified diagram 200 of a computing architecture to programmatically automate feature selection and detection rule creation using an ML framework implementing a simulated annealing process according to some embodiments. Diagram 200 of FIG. 2 includes a data processing pipeline and flow for ML operations that programmatically select features and create detection rules for ML engines and ML model outputs, such as those detection rules and rulesets provided by fraud detection system 120 in conjunction with client device 110 discussed in reference to environment 100 of FIG. 1. In this regard, diagram 200 displays processes for ML detection rule generation utilized by an ML or other AI system, such as ML fraud detection engines 124 of fraud detection applications 122 from environment 100. Thus, the processes in diagram 200 may be utilized to perform decision rule creation in a programmatic manner without user input and/or intervention using a simulated annealing process for feature selection with an iterative rule creation and testing process.

For example, an ML model and/or rules for fraud detection may be trained and created using one or more ML algorithms and historical training data to provide intelligent outputs, such as classifications, decision-making, predictions and the like in an automated manner without user input or intelligence. These models attempt to mimic human thinking by learning from the past historical training data to make correlations, predictions, and interpretations based on pattern analysis and the like. Detection rules may be generated in a manner similar to ML model training and may be generated from decision trees similar to tree-based ML models, as well as neural networks and the like. With decision trees, a tree model may be used where each decision path from the “root” of the tree to a “leaf” may serve as a rule. The rule's maximum complexity may be given by the tree's maximum depth. With neural networks, layers may be trained having nodes with activation functions and weights that are interconnected between layers to resemble neurons and mimic human thinking through feed forward and/or backwards propagation networks.

For AI-driven detection rule generation 202, training dataset 204 may correspond to transactions in a transaction data channel, which may be evaluated for risk and utilized with model training. A date range for the data may be utilized, such as 6 months of transactions. Training dataset 204 may be selected to have an average of at least ˜50 frauds (or similar threshold requirement) per month and provide sufficient samples for rule tuning. Below the selected threshold may be considered a low fraud scenario or other dataset having a low amount of labeled data that may cause issues in accuracy, sampling, and/or model training. From training dataset 204, encrypted (personally identifiable information (PII)) related features may be discarded, as well as key indicator variables. Additionally, zero variance features, categorical features with a cardinality greater than 100 (which may cause a “curse of dimensionality” issue), and/or highly correlated features (e.g., as measured using a Pearson Correlation matrix) may be discarded. An intelligent down sampling approach may be used based on the ratio of fraudulent (or other labeled data) to non-fraudulent transactions, or other selected data record labels. The parties may be marked “clean,” if they have no reported frauds over the duration, or “fraud,” if one or more frauds are reported. For clean parties, a percentage of all transactions may be selected depending on the volume of transactions in the month or other time period. For fraud parties, all transactions and tagged frauds may be selected. If no demarcation between fraud and clean may be made, sampling of a portion depending on the volume of transactions in that time period may selected, and the resulting selections are combined to the sampled dataset.

During training of rules by AI-driven detection rule generation 202, features considered for model and/or rule inclusion may be determined, such as those features available to an ML platform's decision processes at a time of execution (e.g., available to an ML model trainer and/or decision platform of a service provider). This may include a variety of features describing the transaction and/or the party initiating the transaction, which may be based on selected ML features (also referred to as variables) of the transaction used for ML model training. Feature engineering may be performed by AI-driven detection rule generation 202 using domain knowledge to extract features from raw data (e.g., variables) in training dataset 204. For example, data features may be transformed from specific transaction variables, account or user variables, and the like. Features may be initially selected based on business logic and/or by a data scientist or analyst, and a simulated annealing process may be used to select subsets of features for robust detection rule generation by AI-driven detection rule generation 202. During feature engineering, features may be identified and/or selected using this simulated annealing process. For categorical features having a cardinality less than 100 (or other threshold) and not filtered, one-hot encoding may be used to create continuous features. For date/time-type features, a time period between the transaction or other activity date and a corresponding specific event may be calculated using an hour of the day, day of the month, day of the week, or other time domain. Thereafter, an initial batch of features may be established and have their corresponding data encoded for training.

During a data preprocessing 206, data preparation may further occur by performing data cleaning, under sampling, and feature engineering. During data preprocessing 206, a dataset, such as one containing financial transactions for fraud alerts and detection (although other data may also or instead be used), may be split into different tables. In some embodiments, these may be time-consecutive tables used for training the model and generating rules, selecting the rules, and/or evaluating rule performance. Feature engineering may be applied to the tables, which may include a process for selecting from existing features or variables in an ML modeling system or creating new features. Additionally, different model hyperparameters may be checked and hyper tuned to find a set that maximizes rule performance for DR. FPR, or a combination thereof. Thus, data preprocessing 206 may include training data splitting (e.g., into test, validation, and evaluation time-consecutive groups), feature engineering, and/or model hyperparameters optimization.

Thereafter, one or more detection rules may be trained in this manner and using operations and algorithms similar to decision tree ML model training by applying feature selection by simulated annealing 210. This may create subsets of features used to create different detection rules using one or more ML algorithms and/or model training operations. For example, decision tree training with selected features 212 may then be performed based on the selected features from the simulated annealing process. With decision trees, inputs for those features may be used to train and provide an output classifier, such as a classification of transaction fraud. Decision trees may include different branches and layers to each branch, such as an input layer, one or more branches with computational nodes for decisions that branch or spread out, and an output layer, each having one or more nodes. However, different layers, branches, and/or nodes may also be utilized. For example, decision trees may include as many branches between an input and output nodes and/or as many layers as necessary or appropriate. Nodes in each branch and/or layer may be connected to further nodes to form the branches. In this example, decision trees receive a set of input values or features and produce one or more output values, such as risk scores and/or fraud detection probability or prediction. However, different and/or more outputs may also be provided based on the training. When decision trees are used to, each node in the input layer may correspond to a distinct attribute or input data type derived from the training data.

In some embodiments, each of the nodes in a branch, when present, generates a representation, which may include a mathematical computation (or algorithm) that produces a value based on the input values of the input nodes. The mathematical computation may include assigning different weights to each of the data values received from the input nodes. The branch nodes may include one or more different algorithms and/or different weights assigned to the input data and may therefore produce a different value based on the input values. The values generated by the nodes may be used by the output layer node to produce an output value. When an ML model is used, a risk score or other fraud detection classification, score, or prediction may be output from the features. ML models for decision trees may be separately trained using training data during iterative training, where the nodes in the branches may be trained (adjusted) such that an optimal output (e.g., a classification) is produced in the output layer based on the training data.

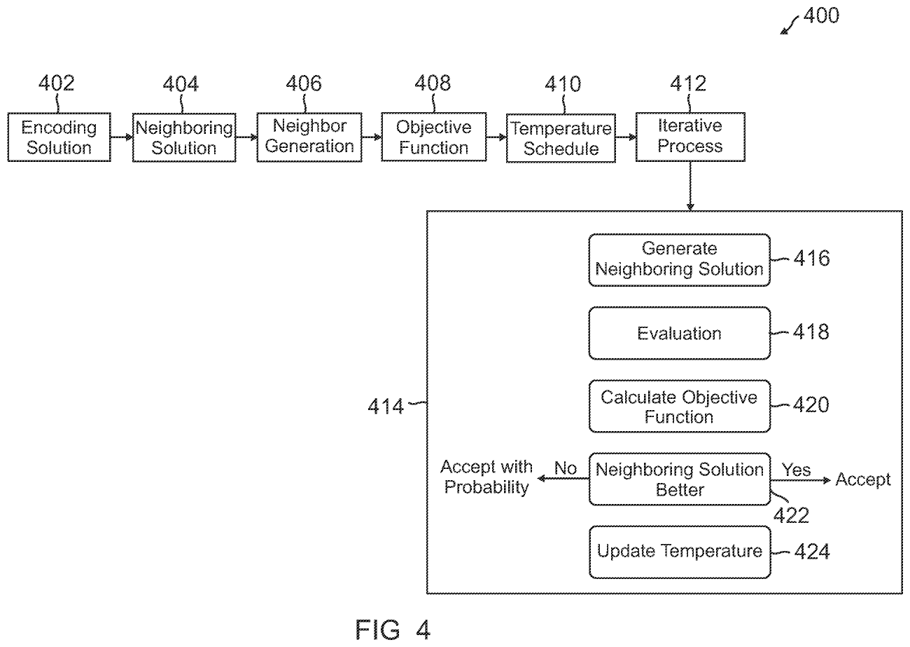

After decision tree training with selected features 212, rule extraction and metric evaluation 214 may be performed to determine each rules effectiveness at fraud detection, as measured using DR, FPR, and the like. Based on the results and/or analysis of the detection rules from rule extraction and metric evaluation 214, rules selection 216 may be performed, which may group rules into subsets of rules for fraud detection ML tasks. Threshold detection coverage 218 may be evaluated to determine if a detection coverage meets or exceeds 50% or another established threshold. If no, second iteration 220 may be executed where data may further be prepared, and undiscovered frauds used for further iterations of rule selection. However, if yes, the detected coverage does meet or exceed the threshold, rule test set evaluation 222 may be performed using test dataset 224. The operations of components 210-220 are described in further detail with regard to FIG. 4 below.

In diagram 200, the flow continues by feeding the final output of generated intelligent rules 226 to Policy Manager Rules (PMX) 228 acting as a module that utilizes the rules with internal capabilities to determine if an “alert” is to be raised for a transaction. Effective, high-quality alerts may be expected from PMX 228 using new, accurate, and efficient detection rules. As such, generated intelligent rules 226 may be periodically or continuously provided and updated with PMX 228 for more accurate, robust, and up-to-date fraud detection. Within diagram 200, initial or historical transaction data along with fraud tags are taken from the database to be used as training data. Thus, after simulated annealing is used for selection of effective features that can be used to generate quality rules, and these features are used to fit a decision tree classifier having a satisfactory DR and FPR, generated intelligent rules 226 are considered by PMX 228 after satisfying rule test set evaluation 222. Once all the rules are combined and verified for performance on test dataset 224, PMX 2268 may utilize these rules with model transaction risk scores for alert generation decision-making. PMX 228 may then act on transaction data 230, such as by executing one or more of actions 232.

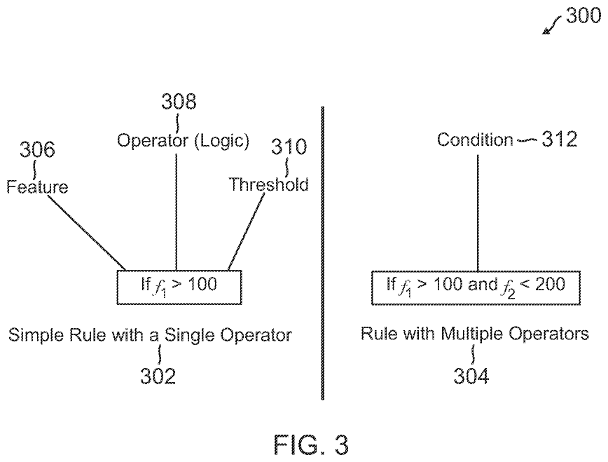

FIG. 3 is a simplified diagram 300 of detection rules that are automatically created using an ML framework implementing a simulated annealing process according to some embodiments. In diagram 300, different rules are shown resulting from rule generation based on decision tree modeling using features selected from a simulated annealing process. In this regard, a single operator rule 302 and a multiple operator rule 304 may be generated using the applications, platforms, and components of fraud detection system 120, such as rule creation platform 130, discussed in reference to environment 100 of FIG. 1.

Single operator rule 302 and multiple operator rule 304 may correspond to representations of an inequality that contains logical operators, features, thresholds, and conditions determined using decision tree modeling based on the feature selection and rule creation discussed herein. In this regard, a rule, such as single operator rule 302, may include one or more features, where a rule that includes multiple features and one or more conditions may correspond to a compound rule, such as multiple operator rule 304. In this regard, single operator rule 302 further includes an operator 308, or the logic that operates on feature 306, such as an attribute or variable of a transaction (e.g., a particular piece of data for the transactions).

Operator 308 performs an operation using feature 306 based on a threshold 310, where meeting, exceeding, or failing to meet threshold 310 with single operator rule 302 may have a corresponding effect or output on fraud detection or risk analysis. With multiple operator rule 304, a condition 312 may allow for multiple operators to function together so that one or more features are compared to multiple threshold when performing an action (e.g., transaction flagging, approving, denying, or the like). Single operator rule 302 and multiple operator rule 304 may therefore correspond to coded statements, functions, or the like that establish a set of feature comparisons to perform fraud analysis or other AI decision-making. Single operator rule 302 and multiple operator rule 304 may be generated using simulated annealing for feature selection and iterative rule creation, as discussed with regard to FIG. 4 below.

FIG. 4 is a simplified diagram 400 of ML operations used for automatic feature selection and rule creation using a simulated annealing process according to some embodiments. Diagram 400 of FIG. 4 includes ML operations that programmatically perform feature selection for detection rule creation using a simulated annealing operation from training data, such as those detection rules provided by fraud detection system 120 to client device 110 discussed in reference to environment 100 of FIG. 1. In this regard, diagram 400 displays blocks 402-414 executed during the simulated annealing process by fraud detection system 120, such as using rule creation platform 130.

In diagram 400, block 402 includes encoding an initial solution, where the combination of features are encoded as a solution vector. This may correspond to encoding each element from features for a vector in the vector, where the features correspond to specific aspects of the rule. For example, the features can be represented as indices or binary values in the vector. At block 404, the solution is initialized where a random initial solution may be generated by selecting a random combination of features. With initializing the solution, the initial solution may be evaluated using the labeled dataset and corresponding F1 score. At block 406, neighbor generation is performed. Neighbor generation may include defining a neighborhood function that generates a new solution by modifying the current solution in some aspect or manner. This modification may be done by changing one or more elements of the solution vector, such as adding or removing a feature.

At block 408, an objective function is defined. An objective function is defined so as to calculate an F1 score of the decision tree classifier to reflect the quality of a solution. At block 410, a temperature schedule is defined, where an initial temperature and cooling schedule is established. For example, an initial temperature and a cooling schedule for the simulated annealing process may be established where the “temperature” controls the probability of accepting worse solutions to the objective function, which may be essential for escaping local optima, and the “cooling schedule” gradually decreases the temperature, making the algorithm more selective over time. At block 412, the iterative process for feature selection using simulated annealing may be initiated, where sub-blocks 416-424 of block 414 may be repeated in an iterative process until a stopping criterion is met (e.g., a maximum number of iterations or a predefined temperature threshold).

Sub-blocks 416-424 of block 414 during the iterative process may begin where a neighboring solution is generated from the current solution using the neighborhood function previously utilized at block 406. At sub-block 418, the neighboring solution is evaluated using the labeled dataset, and the neighboring solution's F1 score is calculated. The evaluation and scores may be used for determining the performance of the neighboring solution. At sub-block 420, the objective function for the neighboring solution is calculated, such as using the same or similar process for block 408. At sub-block 422, a difference in objective function values between the neighboring and current solutions is computed.

If the neighboring solution is better (e.g., a higher objective function value), the neighboring solution may be accepted as the new current solution. If the neighboring solution is worse, the neighboring solution may be accepted with a probability that depends on the difference in objective function values and the current temperature. At sub-block 424, the temperature is then updated according to the cooling schedule. As a result, the final solution vector obtained at the end of the iterative process may represent an optimized combination of features that maximizes harmonic mean of precision and recall (e.g., F1 score) for the given training dataset. An exemplary formula for performing simulated annealing may be performed using the following Equation 1:

Initialize a starting solution s, initial temperature T_init, final temperature T_final, cooling rate α, and maximum iterations per temperature N_iter. Set the current temperature T to T_init. Repeat the following steps until T is less than or equal to T_final. For i from 1 to N_iter: Generate a neighboring solution s′ from the current solution s. Calculate the objective function values for both solutions: f(s) and f(s′). Calculate the change in the objective function, Δf=f(s′)−f(s). If Δf>0, accept the neighboring solution (i.e., set s=s′). Otherwise, accept the neighboring solution with probability P(accept)=exp(Δf/T). Update the temperature T=α*T. The acceptance probability P(accept) is defined as: P(accept)=exp(Δf/T). Equation 1:

As such, ML models and algorithms may be used generate a set of rules used for detecting fraudulent transactions. This process involves selecting a subset of “X” available features, which may be selected in the feature selection stage. X may be any number of features less than the total number of available features, which may be used to generate rules that have a high DR and low FPR. This may be performed using a probabilistic optimization algorithm, where the indicative features may then be used to generate rules from a decision tree classifier. The algorithm may explore the solution space by iteratively generating and evaluating neighboring solutions by accepting better solutions with a higher probability and allowing occasional acceptance of worse solutions to escape local optima.

After simulated annealing, rules may be created and selected for an ML task, such as fraud detection. All features from the best solution vector with a value of 1 may be extracted, and a decision tree classifier may be fitted with the selected features and existing training dataset. The classifier object for the decision tree classifier may be hyper tuned using a set of hyperparameters, such as “min_samples_split->default=2”, “min_impurity_decrease->default=0.0”, and “max_depth=6.” Following rule creation, rule selection may be performed where one rule is selected at a time and a number of total transactions falling into the rule is measured. The FPR (e.g., total number of clean transactions/total number of frauds) and DR (e.g., number of frauds in the rule/total number of frauds) may be calculated, and the rule may be discarded if the FPR is greater than a threshold, such as 100 false positives, and/or the DR is less than a threshold, such as 5% detections. If the total measured detections (e.g., of the fraud transactions) is less than 50% (or another threshold), then a second iteration may be performed. Otherwise, if above 50%, the rules may be output as the final set of rules for implementation with the ML engine(s).

During the second iteration, if required, the fraud that were not covered in the first iteration may be selected and those that were detected may be removed from the training dataset. The other data may remain the same including use of the same or similar down sampling data. Feature selection may then be performed in a further iteration to determine the best solution via the simulated annealing process outlined above, however, with a reduced cooling rate in the second or further iteration. By changing the cooling rate, the algorithm and process for simulated annealing may become less explorative and therefore provide rules more precisely tuned to the frauds that were missed. Rules are again selected one at a time and FPR and DR calculated and compared to the threshold. The final list may result from the rules that have an FPR less than 150 and/or DR less than 3%, or another requisite threshold. Rule performance may then be determined and, based on FPR and DR, a performance chart for each rule's FPR and DR may be generated and provided for rule review during implementation.

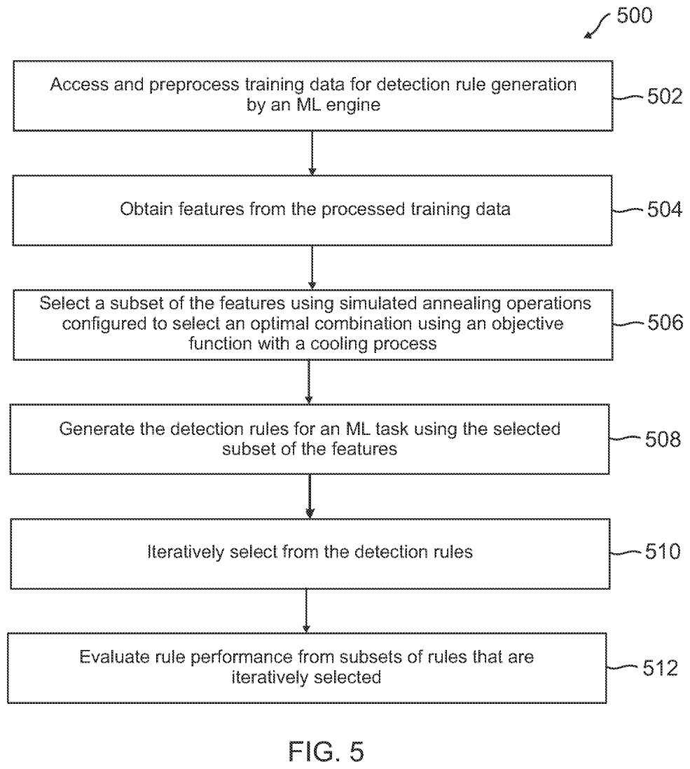

FIG. 5 is a simplified diagram of an exemplary flowchart 500 for programmatically automating rule creation for detection rules using a machine-learning driven computing framework according to some embodiments. Note that one or more steps, processes, and methods described herein of flowchart 500 may be omitted, performed in a different sequence, or combined as desired or appropriate based on the guidance provided herein. Flowchart 500 of FIG. 5 includes operations for detection rule generation through feature selection using simulated annealing, as discussed in reference to FIG. 1-4. One or more of steps 502-512 of flowchart 500 may be implemented, at least in part, in the form of executable code stored on non-transitory, tangible, machine-readable media that when run by one or more processors may cause the one or more processors to perform one or more of steps 502-512. In some embodiments, flowchart 500 can be performed by one or more computing devices discussed in environment 100 of FIG. 1.

At step 502 of flowchart 500, training data for detection rules generation by an ML engine is accessed and preprocessed. The feature selection and rule training data may be received for training of the ML model(s) from one or more data channels, streams, or domains, such as transaction data over a time period (e.g., last 6 months, January-June of last year, etc.). The dataset may include data records and/or values for different features of ML models, which may also be sampled or segmented into datasets for training, validating, testing, and the like. The dataset may be received over a course of time for training of the ML model and may include labels for valid transactions and fraudulent transactions. Preprocessing may include preparing the data for processing, as well as encoding categorical data and/or other data in an initial format to a format usable for ML model training (e.g., feature values or the like). At step 504, features are obtained from the processed training data. Features may be obtained by determining the features for particular transactions and/or other data records in the training data based on those engineered and/or established for a particular ML or other AI task. The features that are obtained may have corresponding feature data, which may be extracted and/or encoded from data for the features in the training data.

At step 506, a subset of the features are selected using simulated annealing operations configured to select an optimal combination using an objective function with a cooling phase. The simulated annealing operations may include initializing an initial solution where the features from step 504 are encoded as a vector and each element in the vector represents a specific aspect of the rule (e.g., as indices, binary values, etc.). An initial solution is generated with a neighborhood function to create a new solution by modifying the current solution. The objective function is then defined and a temperature and cooling schedule for simulated annealing is established. This allows an iterative process for feature selection to occur until a stopping criterion is met, which allows for feature selection in an automated and intelligent manner.

At step 508, the detection rules are generated for an ML task using the selected subset of the features. Detection rules may be generated using the subset(s) of features by extracting the features from the “best” or selected solution vector with a value of 1 and fitting a decision tree classifier with the selected features and existing training data. The classifier object may then be hyper tuned using hyperparameters and rules may be selected one at a time. For example, decision trees may be generated and trained using tree-based ML or NN algorithms and processes, where different “branches,” or other decision tree segments, pathways, neurons, or the like, represent different detection rules. The decision trees may be iteratively trained by training an initial model and retraining as needed. At step 510, iterative selection from the detection rules occurs for one or more fraud detection strategies. When iteratively selecting, each rule's FPR and DR may be calculated, and rules may be discarded if their FPR and/or DR does not meet or exceed a required threshold, such as by having an FPR greater than an acceptable FPR (e.g., too many false positives) and/or having a DR below an acceptable DR (e.g., too little detections).

At step 512, rule performance is evaluated from subsets of rules that are iteratively selected. For all selected rules, if the total measured detections (e.g., the fraud detection coverage) is less that a threshold, a further iteration of the process may occur. However, if the rules meet or exceed the threshold, the rules may then be used for fraud detection testing and/or review by administrators or data scientists. With the further iteration, the frauds that were not covered and detected by the rules in the first iteration are selected and those detected frauds are removed. Feature selection again may be performed using simulated annealing with a modified cooling rate to allow the algorithm to become less explorative. Further rules are generated and then used for testing and/or deployment with fraud detection. One or more interfaces may be provided for users, teams, entities, or the like to review proposed rules for alerting on the ML classification task. Customers and tenants may then apply the rules and actions to alert detection and generation systems implementing ML models and engines.

As discussed above and further emphasized here, FIGS. 1, 2, 3, 4, and 5 are merely examples of fraud detection system 120 and corresponding methods for programmatic decision rule creation using simulated annealing for feature selection, which examples should not be used to unduly limit the scope of the claims. One of ordinary skill in the art would recognize many variations, alternatives, and modifications.

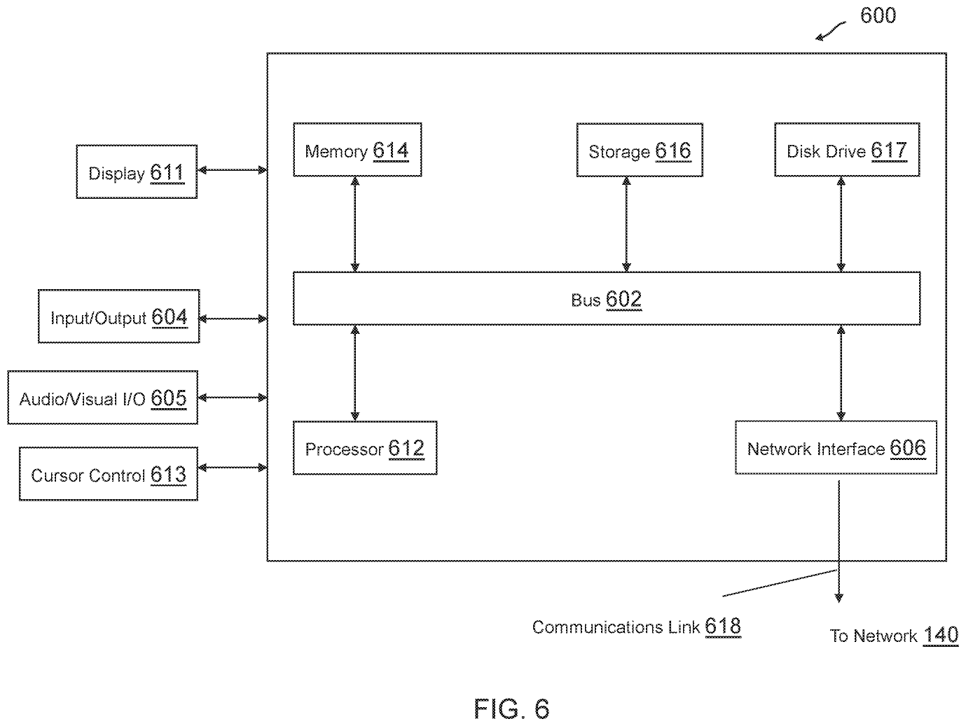

FIG. 6 is a block diagram of a computer system 600 suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 600 in a manner as follows.

Computer system 600 includes a bus 602 or other communication mechanism for communicating information data, signals, and information between various components of computer system 600. Components include an input/output (I/O) component 604 that processes a user action, such as selecting keys from a keypad/keyboard, selecting one or more buttons, image, or links, and/or moving one or more images, etc., and sends a corresponding signal to bus 602. I/O component 604 may also include an output component, such as a display 611 and a cursor control 613 (such as a keyboard, keypad, mouse, etc.). An optional audio/visual input/output component 605 may also be included to allow a user to use voice for inputting information by converting audio signals. Audio/visual I/O component 605 may allow the user to hear audio, and well as input and/or output video. A transceiver or network interface 606 transmits and receives signals between computer system 600 and other devices, such as another communication device, service device, or a service provider server via network 140. In one embodiment, the transmission is wireless, although other transmission mediums and methods may also be suitable. One or more processors 612, which can be a micro-controller, digital signal processor (DSP), or other processing component, processes these various signals, such as for display on computer system 600 or transmission to other devices via a communication link 618. Processor(s) 612 may also control transmission of information, such as cookies or IP addresses, to other devices.

Components of computer system 600 also include a system memory component 614 (e.g., RAM), a static storage component 616 (e.g., ROM), and/or a disk drive 617. Computer system 600 performs specific operations by processor(s) 612 and other components by executing one or more sequences of instructions contained in system memory component 614. Logic may be encoded in a computer readable medium, which may refer to any medium that participates in providing instructions to processor(s) 612 for execution. Such a medium may take many forms, including but not limited to, non-volatile media, volatile media, and transmission media. In various embodiments, non-volatile media includes optical or magnetic disks, volatile media includes dynamic memory, such as system memory component 614, and transmission media includes coaxial cables, copper wire, and fiber optics, including wires that comprise bus 602. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 618 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Although illustrative embodiments have been shown and described, a wide range of modifications, changes and substitutions are contemplated in the foregoing disclosure and in some instances, some features of the embodiments may be employed without a corresponding use of other features. One of ordinary skill in the art would recognize many variations, alternatives, and modifications of the foregoing disclosure. Thus, the scope of the present application should be limited only by the following claims, and it is appropriate that the claims be construed broadly and in a manner consistent with the scope of the embodiments disclosed herein.

What is claimed is:

1. A rule creation system configured to generate machine learning (ML) rules for fraud detection based on an automated feature selection, the rule creation system comprising:
a processor and a computer readable medium operably coupled thereto, the computer readable medium comprising a plurality of instructions stored in association therewith that are accessible to, and executable by, the processor, to perform rule creation operations which comprise:
accessing a training dataset for determining a plurality of detection rules for a fraud detection ML task of an ML engine;
performing a data preprocessing and a data sampling on the training dataset to obtain a processed and sampled dataset;
obtaining a plurality of features from the processed and sampled dataset using a feature engineering operation;
selecting a subset of features from the plurality of features using simulated annealing operations for the automated feature selection, wherein the simulated annealing operations select the subset of features based on an optimal combination of the plurality of features for the fraud detection ML task;
generating the plurality of detection rules using the subset of features and at least one decision tree training ML operation;
iteratively selecting from the plurality of detection rules for a subset of detection rules based on a calculated false positive ratio and a calculated detection rate for each of the plurality of detection rules when processing the training dataset; and
evaluating a rule performance of each rule in the subset of detection rules.

2. The rule creation system of claim 1, wherein the rule creation operations further comprise:
providing the subset of detection rules with the rule performance to a fraud detection ML system, wherein the fraud detection ML system implements the subset of detection rules for ML alert generation for fraud detection by the fraud detection ML system.

3. The rule creation system of claim 1, wherein the selecting the subset of features from the plurality of features using the simulated annealing operations comprises:
encoding a solution vector to the automated feature selection for the plurality of detection rules using the plurality of features;
generating an initial random solution to the automated feature selection based on a random combination of the plurality of features and the training dataset;
defining a neighbor function to the initial random solution that generates a new solution to the automated feature selection;
defining an objective function that evaluates a quality of the initial random solution and the new solution based on a score associated with a harmonic mean of a precision and a recall for a corresponding solution;
defining an initial temperature and a cooling schedule for the initial temperature by a temperature cooling process of the simulated annealing operations; and
executing an iterative process of the simulation annealing operations using the initial temperature and the cooling schedule until meeting a stopping criterion.

4. The rule creation system of claim 3, wherein the initial temperature controls a probability of accepting the corresponding solution that is worse for the automated feature selection than the initial random solution, the new solution, or a further generated solution, and wherein the cooling schedule reduces, over time, the initial temperature to increase selectivity of the corresponding solution by the temperature cooling process.

5. The rule creation system of claim 3, wherein the stopping criterion corresponds to one of a maximum number of iterations, and wherein the iterative process comprises:
generating one or more additional neighbor functions for one or more additional new solutions;
evaluating each of the one or more additional new solutions;
calculating the objective function for each of the one or more additional new solutions based on the evaluating;
computing a difference in values of the objective function between an existing solution and the new solution;
selecting a highest value from the values based on the computing; and
updating the initial temperature in accordance with the cooling schedule.

6. The rule creation system of claim 5, wherein, on completion of the iterative process, a final resulting solution to the automated feature selection for the subset of features has the score associated with the harmonic mean of the precision and the recall at a highest score approaching 1 between 0 and 1 during the iterative process.

7. The rule creation system of claim 3, wherein the selecting the subset of features comprises:
evaluating an output vector from the simulated annealing operations; and
selecting the subset of features based on ones of the plurality of features having a preestablished value of 1 in the output vector, wherein unselected features of the plurality of features are marked as 0 in the output vector.

8. The rule creation system of claim 1, wherein the iteratively selecting from the plurality of detection rules for the subset of detection rules comprises:
calculating, for each of the plurality of detection rules, a detection rate and a false positive ratio based on a portion of the training dataset corresponding to each of the plurality of detection rules;
discarding a corresponding rule from the selecting when at least one of the detection rate and the false positive ratio fails to meet a corresponding threshold; and
measuring a total measured detection rate for selected detection rules from the plurality of detection rules during a first iteration of the iteratively selecting;
based on the total measured detection rate, selecting the selected detection rules for the subset of detection rules if the total measured detection rate meets or exceeds a detection rate threshold; and
performing a second iteration of the iteratively selecting using undetected data samples from the training dataset with matching features from the plurality of features if the total measured detection rate does not meet or exceed the detection rate threshold.

9. The rule creation system of claim 1, wherein each rule of the plurality of detection rules comprises at least one of the plurality of features and at least one of an operator, a threshold, or a condition that separates two or more of the plurality of features with corresponding operators and thresholds, and wherein the subset of detection rules are selected to maximize a detection rate while minimizing a false positive ratio for alert detection using different subsets of the plurality of detection rules.

10. A method to generate machine learning (ML) rules for fraud detection based on an automated feature selection using a rule creation system, which method comprises:
accessing a training dataset for determining a plurality of detection rules for a fraud detection ML task of an ML engine;
performing a data preprocessing and a data sampling on the training dataset to obtain a processed and sampled dataset;
obtaining a plurality of features from the processed and sampled dataset using a feature engineering operation;
selecting a subset of features from the plurality of features using simulated annealing operations for the automated feature selection, wherein the simulated annealing operations select the subset of features based on an optimal combination of the plurality of features for the fraud detection ML task;
generating the plurality of detection rules using the subset of features and at least one decision tree training ML operation;
iteratively selecting from the plurality of detection rules for a subset of detection rules based on a calculated false positive ratio and a calculated detection rate for each of the plurality of detection rules when processing the training dataset; and
evaluating a rule performance of each rule in the subset of detection rules.

11. The method of claim 10, further comprising:
providing the subset of detection rules with the rule performance to a fraud detection ML system, wherein the fraud detection ML system implements the subset of detection rules for ML alert generation for fraud detection by the fraud detection ML system.

12. The method of claim 10, wherein the selecting the subset of features from the plurality of features using the simulated annealing operations comprises:
encoding a solution vector to the automated feature selection for the plurality of detection rules using the plurality of features;
generating an initial random solution to the automated feature selection based on a random combination of the plurality of features and the training dataset;
defining a neighbor function to the initial random solution that generates a new solution to the automated feature selection;
defining an objective function that evaluates a quality of the initial random solution and the new solution based on a score associated with a harmonic mean of a precision and a recall for a corresponding solution;
defining an initial temperature and a cooling schedule for the initial temperature by a temperature cooling process of the simulated annealing operations; and
executing an iterative process of the simulation annealing operations using the initial temperature and the cooling schedule until meeting a stopping criterion.

13. The method of claim 12, wherein the initial temperature controls a probability of accepting the corresponding solution that is worse for the automated feature selection than the initial random solution, the new solution, or a further generated solution, and wherein the cooling schedule reduces, over time, the initial temperature to increase selectivity of the corresponding solution by the temperature cooling process.

14. The method of claim 12, wherein the stopping criterion corresponds to one of a maximum number of iterations, and wherein the iterative process comprises:
generating one or more additional neighbor functions for one or more additional new solutions;
evaluating each of the one or more additional new solutions;
calculating the objective function for each of the one or more additional new solutions based on the evaluating;
computing a difference in values of the objective function between an existing solution and the new solution;
selecting a highest value from the values based on the computing; and
updating the initial temperature in accordance with the cooling schedule.

15. The method of claim 14, wherein, on completion of the iterative process, a final resulting solution to the automated feature selection for the subset of features has the score associated with the harmonic mean of the precision and the recall at a highest score approaching 1 between 0 and 1 during the iterative process.

16. The method of claim 12, wherein the selecting the subset of features comprises:
evaluating an output vector from the simulated annealing operations; and
selecting the subset of features based on ones of the plurality of features having a preestablished value of 1 in the output vector, wherein unselected features of the plurality of features are marked as 0 in the output vector.

17. The method of claim 10, wherein the iteratively selecting from the plurality of detection rules for the subset of detection rules comprises:
calculating, for each of the plurality of detection rules, a detection rate and a false positive ratio based on a portion of the training dataset corresponding to each of the plurality of detection rules;
discarding a corresponding rule from the selecting when at least one of the detection rate and the false positive ratio fails to meet a corresponding threshold; and
measuring a total measured detection rate for selected detection rules from the plurality of detection rules during a first iteration of the iteratively selecting;
based on the total measured detection rate, selecting the selected detection rules for the subset of detection rules if the total measured detection rate meets or exceeds a detection rate threshold; and
performing a second iteration of the iteratively selecting using undetected data samples from the training dataset with matching features from the plurality of features if the total measured detection rate does not meet or exceed the detection rate threshold.

18. The method of claim 10, wherein each rule of the plurality of detection rules comprises at least one of the plurality of features and at least one of an operator, a threshold, or a condition that separates two or more of the plurality of features with corresponding operators and thresholds, and wherein the subset of detection rules are selected to maximize a detection rate while minimizing a false positive ratio for alert detection using different subsets of the plurality of detection rules.

19. A non-transitory computer-readable medium having stored thereon computer-readable instructions executable to generate machine learning (ML) rules for fraud detection based on an automated feature selection using a rule creation system, the computer-readable instructions executable to perform rule creation operations which comprise:
accessing a training dataset for determining a plurality of detection rules for a fraud detection ML task of an ML engine;
performing a data preprocessing and a data sampling on the training dataset to obtain a processed and sampled dataset;
obtaining a plurality of features from the processed and sampled dataset using a feature engineering operation;
selecting a subset of features from the plurality of features using simulated annealing operations for the automated feature selection, wherein the simulated annealing operations select the subset of features based on an optimal combination of the plurality of features for the fraud detection ML task;
generating the plurality of detection rules using the subset of features and at least one decision tree training ML operation;
iteratively selecting from the plurality of detection rules for a subset of detection rules based on a calculated false positive ratio and a calculated detection rate for each of the plurality of detection rules when processing the training dataset; and
evaluating a rule performance of each rule in the subset of detection rules.

20. The non-transitory computer-readable medium of claim 19, wherein the rule creation operations further comprise:
providing the subset of detection rules with the rule performance to a fraud detection ML system, wherein the fraud detection ML system implements the subset of detection rules for ML alert generation for fraud detection by the fraud detection ML system.
